(19) United States
(12) Patent Application Publication
(10) Pub. No.: US 2012/0055159 A1
(43) Pub. Date: Mar. 8, 2012

(54) Method and apparatus for converting fluid heat energy to motive force

(76) Inventor: Marvin W. Hicks, (US)

(21) Appl. No.: 12/807,354

(22) Filed: Sep. 2, 2010

(51) Int. Cl. F02C 1/04; F01K 1/00

(52) U.S. Cl. 60/650; 60/682; 60/659

(57) ABSTRACT

An apparatus and a method, for converting fluid heat energy to motive force by the heating and pressurization of air, and for storing and delivering motive force to motive force users, which includes at least one air pressurizer. The air pressurizer facilitates the transfer of heat energy contained in a hot fluid to air confined within the air pressurizer, thus pressurizing the air to provide motive force.

### BACKGROUND

The need for a steady supply of energy is ever-increasing. Many useful and brilliant advances have been made, in the last century, in the production and supply of energy. The push, to develop expanding supplies of energy, has been dramatic in the last four or five decades. This push for energy has led to increased energy supplies from an increased number of sources. However, in only the last few decades has a strong focus been placed on the conservation of energy to ensure that future generations have sufficient, reliable energy sources. Our awareness has been raised as to the wasteful and polluting methods we have employed in the production and usage of energy. Staggering amounts of energy are lost daily from industrial smokestacks, combustion engine exhausts, and from us simply passing by the opportunities available to make the most of naturally available and renewable energy sources. Developments must be made to reclaim energy wasted in our daily processes and to utilize readily available and non-polluting energy resources.

### SUMMARY OF THE INVENTION

It is an object of the present invention to provide a method and apparatus for converting fluid energy to motive force which will cause and encourage the employment of under-utilized fluid heat energy sources. The scope of these fluid heat energy sources is almost unlimited. Geothermal wells, industrial coolant streams, exothermic chemical reactions, hot gases from almost any combustion source are only a few fluid heat energy sources.

It is a further object of the present invention to provide a method and apparatus for converting fluid energy to motive force that is economical and easily applied to provide motive force for users at almost any location desired. The present invention may be configured and constructed to be mobile or it may be configured and constructed to be stationary.

It is another object of the present invention to provide a method and apparatus for converting fluid energy to motive force that is easily scalable to match the motive force need of the user as well as scalable to match the fluid heat energy supply.

It is yet another object of the present invention to provide a method and apparatus for converting fluid heat energy to motive force that does not produce pollutants such as carbon monoxide, carbon dioxide, or NOX. The present invention operates at substantially a “zero-emissions”. The present invention configured with an end user, such as an air engine that is used to drive a generator, could play a major role in the production of electricity from waste heat energy with the entire configuration operating at substantially “zero-emissions”.

The apparatus for converting fluid heat energy to motive force, of the invention, is characterized by at least one air pressurizer. The air pressurizer is configured to receive and confine air and heat it until a desired pressure, or motive force, is reached. In a preferred embodiment, the air pressurizer is configured to heat the air by the passage of a hot fluid through heat exchange piping that is configured as an internal member of the air pressurizer. The air that enters the air pressurizer may be ambient, or cooled, or chilled; whichever is readily available or the most economical or the most efficient to use. The air pressurizer may operate on a wide range of pressures, from 20 psig to 600 psig.

The heated and pressurized air in the air pressurizer may be transferred, to a pressurized air storage vessel or to a secondary pressurized air storage vessel, by pressure differential. The maximum operating pressure in the pressurized air storage vessel is thus equal to the maximum pressure achieved by the air pressurizer. The secondary pressurized air storage vessel may be operated at a pressure that is lower than the pressure in the first pressurized air storage vessel to allow for a more complete transfer, to storage, of the pressurized air. The stored air may then be delivered, to users of the motive force of the pressurized air, through a letdown system. As air is delivered to users, the pressure, in the air storage vessel from which the air is delivered, drops. This drop in pressure in the air storage vessel creates the pressure differential by which the air pressurizer transfers heated and pressurized air to the air storage vessels.

In another aspect of the disclosure, a method of converting fluid heat energy to motive force includes the steps of introducing air into an air pressurizer, containing the air within the air pressurizer as it is heated to increase the pressure, releasing the pressurized air to storage, recharging the air pressurizer to repeated the previous steps, and releasing the pressurized air (motive force) to users.

In another aspect of the disclosure, the steps of the said method is controlled by a plurality of local process controllers and at least one process computer.

### BRIEF DESCRIPTION OF THE DRAWINGS

FIG. 1a shows a schematic view of a heating vessel according to a preferred embodiment.

FIG. 1b shows a schematic view of a heating vessel according to another preferred embodiment.

FIG. 2 shows a schematic view of an air pressurizer according to a preferred embodiment.

FIG. 3 shows a schematic view of an air pressurizer and pressurized air storage vessel configured together according to a preferred embodiment.

FIG. 4 shows a schematic view of an apparatus for converting fluid heat energy to motive force, for storage of said motive force, and delivery of said motive force to a user according to a preferred embodiment.

### DETAILED DESCRIPTION

In the following description, the use of “a”, “an”, or “'the” can refer to the plural. All examples given are for clarification only, and are not intended to limit the scope of the invention.

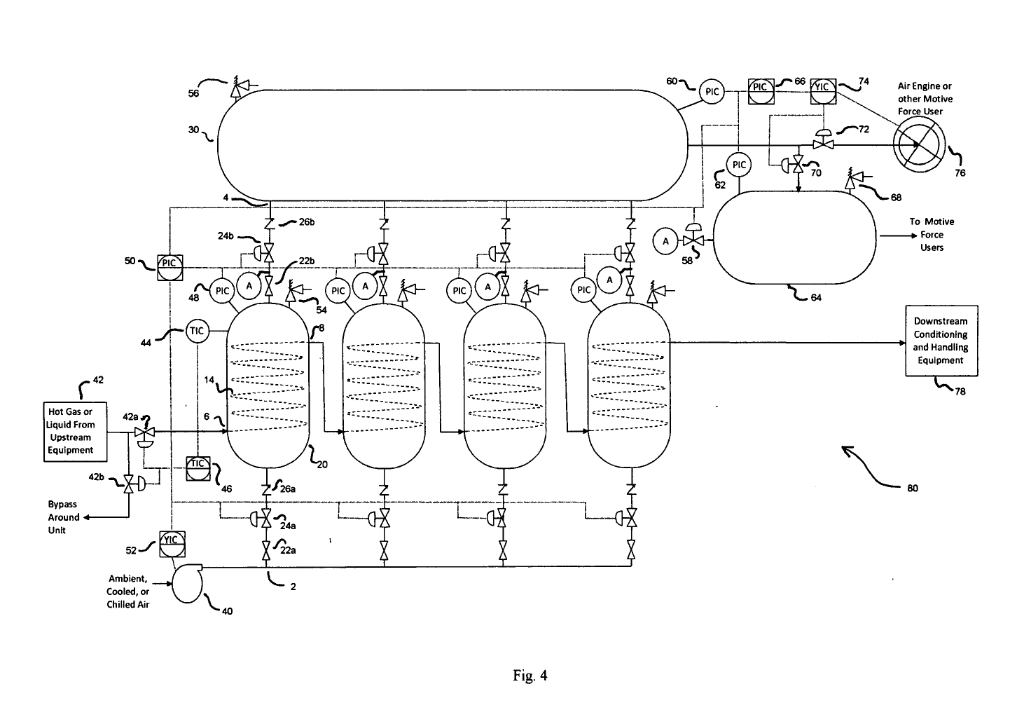

Referring to FIG. 4, according to a preferred embodiment, an apparatus 80 for converting fluid heat energy to motive force and for storage of said motive force and for delivery of said motive force to a user. The apparatus 80 includes at least one air pressurizer 20, connected to at least one pressurized air storage vessel 30. The air pressurizer 20 and the pressurized air storage vessel 30 both connect to at least one secondary pressurized air storage vessel 64 which is configured to operate at a pressure lower than that of the pressurized air storage vessel 30.

The flow of unheated air into the air pressurizer 20, through an unheated air entrance 2, is controlled by an air pump 40, a manual block valve 22a and a control valve 24a. Flow check valve 26a is configured to allow the unheated air to substantially freely flow into the air pressurizer 20 and configured to substantially prevent the reverse flow of unheated or heated air from the air pressurizer 20. The flow of heated and pressurized air from the air pressurizer 20, through heated and pressurized air exit 4, is controlled by the pressure differential between air pressurizer 20 and pressurized air storage vessel 30, a manual block valve 22b and a control valve 24b. Flow check valve 26b is configured to allow the heated and pressurized air to substantially freely flow from the air pressurizer 20 and configured to substantially prevent the reverse flow of the heated and pressurized air from the pressurized air storage vessel 30. The unheated air may be ambient air, cooled air, or chilled air.

A hot fluid source 42 and control valve 42a are configured to allow a hot fluid, with a heat energy that is high relative to the heat energy of the unheated air, to flow into the air pressurizer 20 through hot fluid entrance 6, through the heat exchange piping 14, and exit the air pressurizer 20 through hot fluid exit 8. The heat exchange piping 14 is configured to allow the hot fluid to pass through the interior of the air pressurizer 20 without allowing contact between the hot fluid and air within the air pressurizer 20. The hot fluid may be any liquid or gas or gas and liquid mixture that is compatible with the materials of construction of the heat exchange piping 14.

The apparatus 80 may be configured with a plurality of air pressurizers 20. A plurality of air pressurizers 20 may be configured to accept the flow of hot fluid in series or they may be configured to accept the flow of hot fluid in parallel. Control valves 42a and 42b are configured to allow any proportion of the hot fluid stream to pass through the air pressurizer 20 or to allow any proportion of the hot fluid stream to bypass the air pressurizer 20 and continue downstream of the apparatus 80 to conditioning and handling equipment 78.

The air pressurizer 20 is configured to substantially accomplish the conversion of fluid heat energy to motive force. A simplification of the conversion is governed by a basic gas law, the Gay-Lussac's Law. The formula that expresses this law, P₁/T₁=P₂/T₂, is not an oversimplification of the process that occurs during the conversion of heat energy contained in the hot fluid stream to motive force in the air in the air pressurizer 20. This law builds a bridge from state 1 of a gas to state 2 of a gas.

The air pressurizer 20 is configured to accomplish the conversion of heat energy to motive force by the closing of control valve 24b and then the acceptance of an inflow of unheated air from air pump 40 through unheated air entrance 2, block valve 22a, control valve 24a, and check valve 26a, up to a predetermined pressure. Control valve 24a may then be closed to confine the amount of unheated air pumped into air pressurizer 20. The air pressurizer 20 is further configured to allow a continuous flow of a hot fluid through the heat exchange piping 14. The temperature of the air confined in the air pressurizer 20 will rise, over time, to very closely approach the temperature of the hot fluid. The configuration for the continuous flow of hot fluid from the hot fluid source 42 through the heat exchange piping 14 eliminates the need for process adjustments to compensate for the heat of the hot fluid lost to the air confined in the air pressurizer 20. One skilled in the art would realize that the air pressurizer 20 may be operated with the hot fluid, from the hot fluid source 42, being sent through the heat exchange piping in a mode other than continuous flow.

The following is a mathematical application of the Gay-Lussac's Law to explain the conversion function of the air pressurizer 20. Values may be assigned to the pressure and temperature variables for the unheated air immediately upon confinement of the unheated air in the air pressurizer 20 and for the hot fluid passing through the heat exchange piping 14. Let the temperature of the hot fluid stream be 900° R. Let P₁ and T1 of the unheated air be 120 psia and 540° R, respectively. The values are already absolute, so in a straight forward mathematical exercise, P₂=(120 psia/540° R)*(900° R=200 psia. In this example, the air within the air pressurizer 20, gained 80 psi of motive force. Many potential combinations of process values exist for the air pressurizer 20 and for the apparatus 80. This example is not meant to limit the scope of the invention in any way.

A pressure relief valve 54 prevents the overpressure of the air pressurizer 20. If the pressure within the air pressurizer exceeds a chosen maximum allowable pressure, pressure relief valve 54 opens and relieves the pressure to a safe location until said pressure is below the chosen maximum allowable pressure. The heated and pressurized air in the air pressurizer 20 is transferred to at least one pressurized air storage vessel 30 by leaving control valve 24a closed and opening control valve 24b, if the pressure in the pressurized air storage vessel 30 is lower than the pressure in the air pressurizer 20. The heated and pressurized air is moved into the pressurized air storage vessel by differential pressure through the heated and pressurized air exit 4.

The pressurized air storage vessel 30 may be operated at any chosen pressure between 20 psig and 600 psig. Some factors affecting the determination of the operating pressure of the pressurized air storage tank 30 may be, but are not limited to, the materials of construction and the requirements of a motive force user 76. A pressure relief valve 56 prevents the overpressure of the pressurized air storage vessel 30. If the pressure within the air pressurizer exceeds a chosen maximum allowable pressure, pressure relief valve 56 opens and relieves the pressure to a safe location until said pressure is below the chosen maximum allowable pressure for the pressurized air storage vessel 30.

A secondary pressurized air storage vessel 64 is configured to receive air from the air pressurizer 20 and the pressurized air storage vessel 30. A pressure relief valve 68 prevents the overpressure of the secondary pressurized air storage vessel 64. If the pressure within the air pressurizer exceeds a chosen maximum allowable pressure, pressure relief valve 68 opens and relieves the pressure to a safe location until said pressure is below the chosen maximum allowable pressure for the secondary pressurized air storage vessel 64. The secondary pressurized air storage vessel 64 is further configured to operate at a lower pressure than that of the pressurized air storage vessel 30 while maintaining a pressure high enough to be of value to many users.

The secondary pressurized air storage vessel 64 is of great value in the configuration of the apparatus 80. When the heated and pressurized air in air pressurizer 20 is released to the pressurized air storage vessel 30, the pressure in the air pressurizer 20 eventually falls to match the rising pressure in the pressurized air storage vessel 30. At the point where the two pressures equal, no more of the heated and pressurized air can be transferred without the expenditure of mechanical energy from air pump 40. Such an expenditure of mechanical energy can be costly. When the pressure in the air pressurizer 20 is equal to the pressure in the pressurized air storage vessel 30, control valve 24b can be closed and control valve 58 can be opened to allow more of the valuable motive force contained in the heated pressurized air to be transferred to the secondary pressurized air storage vessel 64. If the secondary pressurized air storage vessel 64 is operated at a low enough pressure, it could be advantageous to sweep the remainder of the heated and pressurized air to the secondary pressurized air storage vessel 64 using air pump 40. This sweeping of the heated and pressurized air from the air pressurizer 20 introduces lower temperature air into the air pressurizer 20, increasing the amount of heat energy that can be extracted, from the hot fluid, and converted to motive force.

The apparatus 80 is configured with instrumentation to allow the monitoring of process variables, such as temperature and pressure, and the apparatus 80 may be operated and controlled by a computer or by a programmable logic controller. The temperature in the air pressurizer 20 may be controlled by the positioning of control valve 42a and control valve 42b. The positioning of these control valves may be determined by a command received from a (computer) temperature indicating controller 46. The temperature indicating controller 46 can make its determination for the positioning of control valves 42a and 42b based on the comparison of an operator input temperature set point and a temperature reading in the air pressurizer 20 sent to it by a local temperature indicating controller 44.

The operation of the air pressurizer 20, control valve 24a, and control valve 24b is controlled by (computer) a pressure indicating controller 50. The air pump 40 is controlled by (computer) an event indicating controller 52. A local pressure indicating controller 48 monitors the pressure inside the air pressurizer 20 and sends the process data to the (computer) pressure indicating controller 50. A local pressure indicating controller 60 monitors the pressure inside the pressurized air storage vessel 30 and sends the process data to a (computer) pressure indicating controller 66. A local pressure indicating controller 62 monitors the pressure inside the secondary pressurized air storage vessel 64 and sends the process data to the (computer) pressure indicating controller 66.

The apparatus 80 may go through the following sequence of events to convert fluid heat energy to motive force. In this example, the local pressure indicating controller 48 sends a signal to a (computer) pressure indicating controller 50 indicating that the pressure inside the air pressurizer 20 is below an operator-entered high pressure set point. The (computer) pressure indicating controller 50 checks the most recent past events and determines that the air pressurizer 20 just discharged heated and pressurized air to the pressurized air storage vessel 30. When the pressure in the air pressurizer 20 equals the pressure in the pressurized air storage vessel 30, the (computer) pressure indicating controller 50 communicates with the (computer) pressure indicating controller 66 to determine this process condition. A local process indicating controller 62 sends a signal to the (computer) process indicating controller 66 indicating the pressure inside the secondary pressurized air storage vessel 64. The (computer) pressure indicating controller 50 communicates with the (computer) pressure indicating controller 66 and determines that the air pressurizer 20 can further discharge to the secondary pressurized air storage vessel 64. The (computer) pressure indicating controller 50 sends signals to close control valve 24b and to open control valve 58. When the pressures inside the air pressurizer 20 and inside the secondary pressurized air storage vessel 64 are equal, the (computer) pressure indicating controller 50 starts air pump 40 and opens control valve 24a to sweep as much of the energized air to the secondary pressurized air storage vessel 64 as is practical. When the pressure inside the air pressurizer 20 reaches an operator set point pressure, the (computer) pressure indicating controller 50 closes control valve 58, closes control valve 24b, closes control valve 24a, and stops air pump 40. The heating and pressurizing of the air confined in the air pressurizer 20 begins. This example is not meant to limit the scope of the invention in any way.

The operation; of the pressurized air storage vessel 30, the secondary pressurized air storage vessel 64, a control valve 70, and a control valve 72; is controlled by the (computer) pressure indicating controller 66. The (computer) pressure indicating controller 66 monitors the pressures in the pressurized air storage vessel 30 and the secondary pressurized air storage vessel 64 by indications from the local pressure indicating controller 60 and the local pressure indicating controller 62, respectively. The (computer) pressure indicating controller 66 may send a signal to the (computer) pressure indicating controller 50 to either start, suspend or resume the process of releasing heated and pressurized air from the air pressurizer 20 to the pressurized air storage vessel 30, based on indications received from the local pressure indicating controller 60. Similar actions of the (computer) pressure indicating controller 66 would be obvious to one skilled in the art.

The (computer) pressure indicating controller 66 also controls the release of the motive force, confined in the pressurized air storage vessel 30, to motive force users 76, through the control valve 72. An (computer) event indicating controller 74 receives a signal from a motive force user 76 that the motive force user 76 requires motive force. The (computer) pressure indicating controller 66 opens control valve 72, sending motive force to the motive force user 76. The pressure upstream of control valve 72 is sustained higher than the pressure downstream of control valve 72, thus control valve 72 acts as a letdown valve when supplying motive force to motive force users 76. Similar actions of the (computer) pressure indicating controller 66 would be obvious to one skilled in the art.

Many different potential embodiments of an apparatus for converting fluid heat energy to motive force and for storage of said motive force and for delivery of said motive force to a user, and many different potential controllers and control methods for said an apparatus, would be apparent to one skilled in the art.

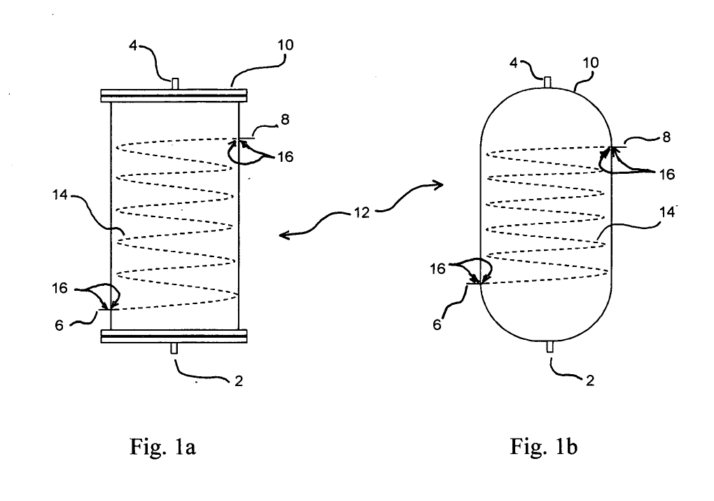

Referring now to FIGS. 1a and 1b, in a preferred embodiment, a heating vessel 12 consists of a vessel 10. The vessel 10 may be constructed as an elliptical-ended vessel or it may be constructed as a flanged pipe-vessel. The vessel 10 may be constructed of any material capable of safely the temperatures and pressures at which heating vessel 12 may be operated. It would be apparent to one skilled in the art that many choices exist for the materials of construction and for the embodiment of the vessel 10. The heating vessel 12 further consists of an unheated air entrance 2 and a heated and pressurized air exit 4. The heating vessel 12 further consists of heat exchange piping 14 configured to fit fully inside the heating vessel 12. The heat exchange piping 14 may be constructed of any material that is compatible with the process conditions chosen. A preferred material of construction for the heat exchange piping 14 may be stainless steel or an alloy. The heating fluid entrance sections 6 and the heating fluid exit sections 8 of the heat exchange piping are configured to pass through the wall of the heating vessel 12, and are welded 16 to the internal and external portions of the heating vessel 12 wall, allowing connection to a hot fluid source 42 (as shown in FIG. 4). One skilled in the art would realize that many configurations of the heat exchange piping 14 exist that allow the heat exchange piping 14 to fit inside the heating vessel 12 that would provide liberal heat exchange area.

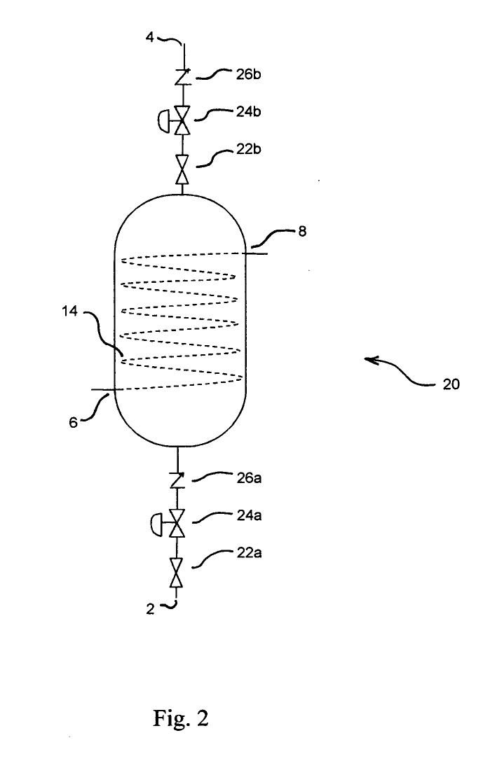

Referring now to FIG. 2, in a preferred embodiment, an air pressurizer 20 configured to receive unheated air through an unheated air entrance 2 into the heating vessel 12 and to exhaust heated and pressurized air through a heated and pressurized air exit 4. Block valves 22a and 22b may be used to manually isolate the air pressurizer 20. Check valves 26a and 26b substantially eliminates the possibility of reverse flow of air as it travels into or as it exits the air pressurizer 20. The air pressurizer 20 is further configured to confine the unheated air received by the closing of control valve 24a and the control valve 24b. The air pressurizer 20 is further configured to allow a hot fluid from the hot fluid source 42 (as shown in FIG. 4) to enter the heat exchange piping 14 of the air pressurizer 20 through a hot fluid entrance 6. The hot fluid may then flow through the heat exchange piping 14 and exit the air pressurizer 20 through a hot fluid exit 8. The hot fluid may be any liquid or gas or liquid and gas mixture compatible with the materials of construction of the heat exchange piping 14.

Heat exchange takes between the hot fluid and the confined air causing the pressure of the confined air to rise until a desired pressure set point, chosen by an operator, is reached. The desired pressure set point may be any reasonable pressure. A reasonable low-end high pressure set point, in a given process, may be at 100 psi. A reasonable high-end high pressure set point, in another given process, may be at 600 psi. Many factors affect the choice of the high pressure set point. One such factor may be the temperature of the hot fluid allowed to enter the heat exchange piping 14 in the air pressurizer 20. A preferred maximum temperature of the hot fluid is 1000° F. This temperature allows construction, of the heat exchange piping 14 and of the air pressurizer 20, from less exotic and expensive metals than if the temperature were higher. Temperatures of 1000° F. or below allow a great amount of storable motive force to be gained by the confined air while avoiding the possibility of thermal NOX formation. These examples were not meant to limit the scope of the invention in any way.

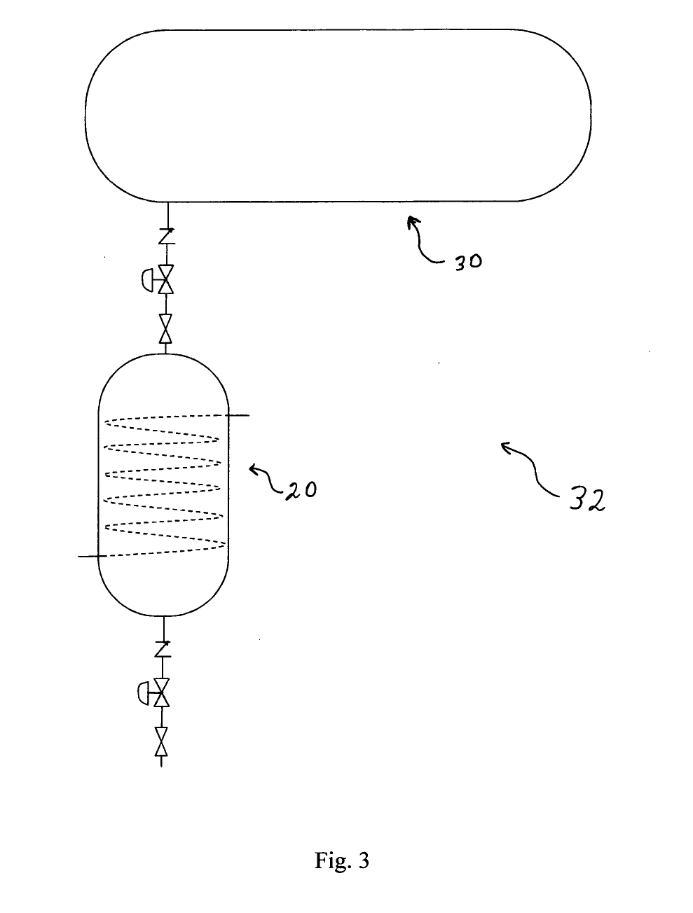

Referring now to FIG. 3, in a preferred embodiment, an air pressurizer and pressurized air storage vessel combination 32, consisting of an air pressurizer 20 and a pressurized air storage vessel 30. The air pressurizer 20 and the pressurized air storage vessel 30 are configured such that air heated and pressurized in the air pressurizer 20 may be transferred to the pressurized air storage vessel 30 and stored as a motive force. The objective of this drawing is to emphasize the greater value and usefulness of the combination of the air pressurizer 20 and the pressurized air storage vessel 30, as compared to the additive value of employing the two separately. When used in combination, the air pressurizer 20 and the pressurized air storage vessel 30 may be configured in close proximity. The more closely the vessels are configured, the lower the amount is, of the motive force, that is lost during the transfer of air from the air pressurizer 20 to the pressurized air storage vessel 30. The vessels, in combination, may be controlled such that the operation of either vessel could be made to benefit the operation of the other vessel. Many different potential embodiments, of an air pressurizer and pressurized air storage vessel combination 32 for converting fluid heat energy to motive force and for storage of said motive force, would be apparent to one skilled in the art.

I claim:

1. An air pressurizer for converting fluid heat energy to motive force by pressurizing air, comprising:
at least one air entrance for unheated air;
at least one air exit for heated, pressurized air;
at least one heating fluid entrance;
at least one heating fluid exit;
heat exchange piping configured to transport a heating fluid through the interior of the air pressurizer without contact between the heating fluid and the air within the air pressurizer.

2. The air pressurizer as claimed in claim 1, wherein the air pressurized may be ambient, cooled, or chilled prior to the introduction of the air into the air pressurizer.

3. The air pressurizer as claimed in claim 1, wherein the heating fluid may be any liquid or gas or liquid and gas mixture compatible with materials used to construct the heat exchange piping.

4. The air pressurizer as claimed in claim 1, comprising:
at least one heating vessel, comprising:
at least one air entrance for unheated air;
at least one air exit for heated, pressurized air;
at least one heating fluid entrance;
at least one heating fluid exit;
internal heat exchange piping configured to transport a heating fluid through the interior of the heating vessel without contacting the air within the heating vessel.

5. The air pressurizer as claimed in claim 4, wherein the heating fluid entrance sections and the heating fluid exit sections of the heat exchange piping are configured to pass through the wall of the heating vessel, and are welded to the internal and external portions of the heating vessel wall, allowing connection to a heating fluid transfer system.

6. The heating vessel as claimed in claim 4, configured for the entrance of unheated air, the confinement of the air to be heated, and the exhaust of the heated and pressurized air.

7. An air pressurizing and storage system for converting fluid heat energy to motive force by pressurizing air, comprising:
at least one heating vessel, comprising:
at least one air entrance for unheated air;
at least one air exit for heated, pressurized air;
at least one heating fluid entrance;
at least one heating fluid exit;
at least one pressurized air storage vessel;
internal heat exchange piping configured to transport a heating fluid through the interior of the heating vessel without contacting the air within the heating vessel.

8. The air pressurizing and storage system for converting fluid heat energy to motive force by pressurizing air as claimed in claim 7, further comprising a heating fluid source upstream of the system configured to deliver heating fluid to the system at no more than 1000 degrees Fahrenheit.

9. The air pressurizing and storage system for converting fluid heat energy to motive force by pressurizing air as claimed in claim 7, further comprising a heating fluid handling system downstream of the air pressurizing and storage system.

10. The air pressurizing and storage system for converting fluid heat energy to motive force by pressurizing air as claimed in claim 7, further comprising a pressure letdown system downstream of the pressurized air storage vessel configured to supply motive force air to a user at a desired volume and pressure.

11. The air pressurizing and storage system as claimed in claim 7, wherein the air pressurized may be ambient, cooled, or chilled prior to the introduction of the air into the air pressurizer.

12. The air pressurizing and storage system as claimed in claim 7, wherein the heating fluid may be any liquid or gas or liquid and gas mixture compatible with materials used to construct the heat exchange piping.

13. A method for converting fluid heat energy to motive force by pressurizing air, comprising:
providing an air pressurizing and storage system for converting fluid heat energy to motive force by pressurizing air as claimed in claim 7.

14. A method for converting fluid heat energy to motive force by pressurizing air as claimed in claim 13, further comprising:
providing a heating fluid source.

15. A method for converting fluid heat energy to motive force by pressurizing air as claimed in claim 14, further comprising:
introducing unheated air into the heating vessel;
confinement of the unheated air within the heating vessel until desired or maximum pressure of the air is reached.

16. A method for converting fluid heat energy to motive force by pressurizing air as claimed in claim 15, further comprising:
release of the heated, pressurized air from the heating vessel and into a pressurized air storage vessel, wherein the air is stored as a potential motive force until it is dispensed to a user via a letdown system.

17. A method for converting fluid heat energy to motive force by pressurizing air as claimed in claim 16, further comprising:
providing a process control system to cause said method to be controllable in automatic mode or in manual mode.
